(19) United States
(12) Patent Application Publication
(10) Pub. No.: US 2012/0160525 A1
(43) Pub. Date: Jun. 28, 2012

(54) VIDEO-BASED FIRE DETECTION AND SUPPRESSION WITH CLOSED-LOOP CONTROL

(75) Inventors: Alan Matthew Finn, Hebron, CT (US); Pei-Yuan Peng, Ellington, CT (US); Rodrigo E. Cabballero, Middletown, CT (US); Ziyou Xiong, Wethersfield, CT (US); Hongcheng Wang, Vernon, CT (US)

(73) Assignee: UTC FIRE AND SECURITY CORPORATION, Farmington, CT (US)

(21) Appl. No.: 13/000,702

(22) PCT Filed: Dec. 22, 2010
(86) PCT No.: PCT/US2008/007793

§ 371 Date: Dec. 22, 2010

(51) Int. Cl. A62C 35/00; H04N 7/18

(52) U.S. Cl. 169/5; 348/143; 348/E07.085

(57) ABSTRACT

A closed-loop system employs video analytic outputs in a feedback loop to control the operation of a video-based fire detection system. In particular, video data captured by a video detector is analyzed by a video analytic system to generate outputs identifying regions indicative of fire. These outputs are employed as feedback in a closed-loop control system to orient the camera such that field of the view of the camera is modified to improve the ability of the video analytic system to verify or confirm the presence of fire within a region identified as indicative of fire. In addition, video analytic system may generate outputs identifying the delivery location of a fire suppressant. These outputs are employed as feedback in a closed-loop control system to orient the delivery of suppressant to extinguish the fire.

### BACKGROUND

The present invention relates generally to computer vision and pattern recognition and in particular to video analytics employed in feedback control systems.

The use of video data to detect the presence of fire has become increasingly popular due to the accuracy, response time, and multi-purpose capabilities of video recognition systems. Typically, a video analytics system calculates one or more video metrics or features associated with video data provided by a video detector. Based on the calculated metrics, the video analytic system determines whether the video data indicates the presence of fire.

As with all types of detection, video-based detection of fire includes an inherent trade-off between the probability of a false alarm and a missed detection. A false alarm occurs when the video analytics system incorrectly interprets video data as indicative of fire when no fire is present. Likewise, a missed detection occurs when the video analytics system fails to detect the presence of a fire when a fire is in fact present.

Traditional video analytics systems employ a number of tactics to prevent both false alarms and missed detections. For example, a conventional video analytics system may require a detected fire situation to persist for some length of time before an alarm is triggered. This “wait and see” approach reduces the number of nuisance alarms, but also builds delay into the system to the detriment of fire prevention methods. In addition, this method does not reduce the uncertainty associated with the video-based fire detection, other than confirming that the phenomenon was not transient in nature.

Video analytics are typically used in video-based fire detection systems to simply detect the presence of fire. The detected presence of fire may result in some action taking place (e.g., triggering an alarm), and may even result in action directed specifically towards suppressing the fire (e.g., dispensing fire suppression agents in an area indicated to include fire). In each case however, the output of the video analytic system is used in an open-loop manner. That is, a conventional system may direct fire suppression agents to an area indicated to include fire based on extensive pre-calibration, (e.g., for suppressant pressure and directivity) and assumptions about the likely ambient conditions, (e.g., wind speed), and fire size, (e.g., suppressant dispersal pattern). If any of these conditions do not prevail, for instance the system has become miscalibrated over time, the suppressant will not automatically suppress the fire.

A need remains for systems and methods for improving the ability of video analytic systems to detect the presence of fires without false alarms or missed detections and to reliably direct the automatic suppression of fire regardless of ambient conditions and equipment calibration.

### SUMMARY

Described herein is a closed-loop feedback system that employs video analytics generated in response to video input as feedback used to control the operation of the system. The closed-loop system includes a video analytic system operably connectable to receive video data from a video detector and to generate in response video analytic feedback identifying regions within a field of view of the video detector indicative of fire. A controller is connected to receive the video analytic feedback generated by the video analytic system, and generates in response control instructions employed to control the orientation of the video detector.

In another aspect, a closed-loop system that employs video analytic feedback to direct the deployment of a fire suppressant is described. The system includes a video analytic system operably connectable to receive video data from a video detector and to generate in response video analytic feedback identifying regions within a field of view of the video detector indicative of fire. The video analytic system also generates video analytic feedback identifying the delivery location of the fire suppressant. A controller is connected to receive the video analytic feedback and to generate in response control instructions provided to control the operation of the fire suppressant delivery system such that the error between the region identified as indicative of fire and the location of the delivered fire suppressant is minimized.

In another aspect, a method of employing video analytics in a closed-loop system to detect the presence of fire is described. Video data acquired from a video detector is analyzed using video analytics to identify regions within a field of view of the video detector indicative of fire. The video analytics are applied as feedback to a controller, which generates control instructions to modify the field of view of the video detector based on the video analytic feedback to maximize the ability of a video analytic system to reliably identify the presence of fire within the field of view of the video detector. Video analytics generated in response to the redefined field of view are calculated to verify whether the region identified as indicative of fire actually contains fire.

In another aspect, a method of employing video analytics in feedback to control the delivery of a fire suppressant agent is described. As part of the method, video data is acquired from a video detector. Video analytics are applied to the acquired video data to calculate video analytic feedback that identifies regions within the field of view of the video detector indicative of fire as well as a delivery location of a fire suppressant delivered in response to the detected fire. The calculated video analytic feedback is provided as feedback to a controller, which calculates control instructions that are used to modify the delivery of the fire suppressant such that the difference between the region identified as indicative of fire and the delivery location of the fire suppressant is minimized. The calculated control instructions are provided to a fire suppressant delivery system to modify the delivery location of the fire suppressant.

### BRIEF DESCRIPTION OF THE DRAWINGS

FIG. 1 is a block diagram illustrating an exemplary embodiment of the present invention that employs video analytics in a feedback loop to control the operation of the video detector.

FIG. 2 is a block diagram illustrating an exemplary embodiment of the present invention that employs video analytics in a feedback loop to control the deployment of a fire suppression agent.

### DETAILED DESCRIPTION

The present invention is directed to a video-based fire detection system that employs video analytics in a feedback loop. Employing video analytics in a feedback system allows a video detector to become a multi-purpose sensor in a system of unique capabilities. Video analytics are typically used in video-based fire detection systems to simply detect the presence of fire. The detected presence of fire may result in some action taking place (e.g., triggering an alarm), and may even result in action directed specifically towards suppressing the fire (e.g., dispensing fire suppression agents in an area indicated to include fire). In each case, however, the output of the video analytic system is used in an open-loop manner. In a conventional system, analyzing video input to detect the presence of fire either results in the detection of fire or it does not. Likewise, in a conventional system directing fire suppression agents to an area indicated to include fire either results in the fire being extinguished or it does not. The present invention provides a mechanism for including the output of the video analytic system in a feedback loop that can be used to improve the operation of the video-based fire detection system.

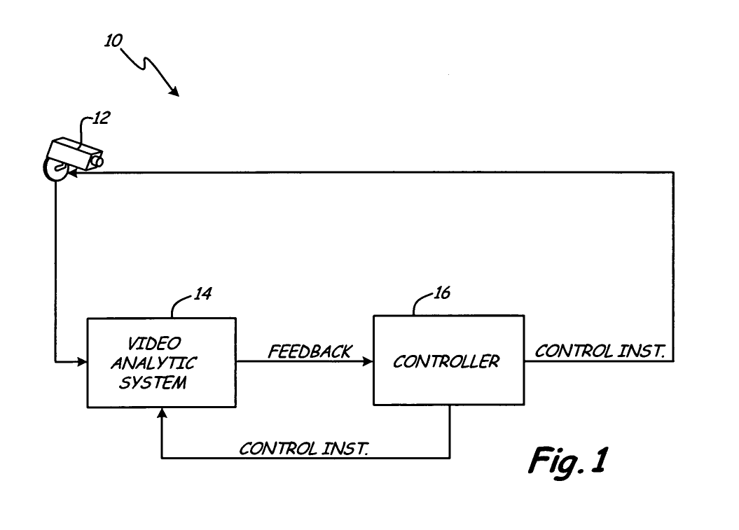

FIG. 1 is a block diagram that illustrates a closed-loop, video-based fire detection system 10 that employs video analytics in a feedback loop to control the operation of video-based fire detection system 10. Video-based fire detection system 10 includes video detector 12, video analytic system 14, and controller 16.

Video detector 12 may be a video camera or other image data capture device. The term video input is used generally to refer to video data representing two or three spatial dimensions as well as successive frames defining a time dimension. In one embodiment, video input is defined as video input within the visible spectrum of light. However, the video detector 12 may be broadly or narrowly responsive to radiation in the visible spectrum, the infrared spectrum, the ultraviolet spectrum, or combinations of these broad or narrow spectral frequencies. The provision of video data by video detector 12 to video analytic system 14 may be by any of a number of means, e.g., by a hardwired connection, over a dedicated wireless network, over a shared wireless network, etc. In another embodiment, rather than being embodied as independent components, video analytic system 14 may be embodied as part of video detector 12.

Video analytic system 14 includes a combination of software and hardware capable of analyzing the video data provided by video detector 12 to detect the presence of fire. Analysis of the video data includes calculating one or more video metrics and analyzing the video metrics to determine whether the video data provided by video detector 12 is indicative of fire. In particular, the calculated video metrics are often analyzed to determine and identify particular regions within the field of view of video detector 12 that are indicative of fire.

A variety of well-known video analytic metrics (e.g., color, intensity, frequency, etc) and subsequent detector schemes (e.g., neural network, logical rule-based system, support vector-based system, etc.) may be employed to identify the presence of fire within the field of view of video detector 12. In addition to a simple identification of regions detected as indicative of fire, video analytic system 14 may also calculate certainties or probabilities associated with a particular region indicating the presence of fire.

In a conventional open-loop system, the video analytic metrics and detection schemes are employed to determine whether or not a detected event is indicative of fire. For example, if the calculated metric exceeds some threshold value, the conventional video analytic system may respond by triggering an alarm. The closed-loop system of the present invention employs the video analytics output (e.g., location, size, probabilities associated with a detected event being a fire event, etc.) as feedback that is used to control the operation of video detector 12.

In one embodiment, the video analytic feedback is employed to control the orientation of video detector 12. In particular, the video analytic feedback is employed to modify the field of view of video detector 12 such that video analysis of the modified field of view results in improved certainty associated with fire detection. In this embodiment, controller 16 seeks to minimize the difference between the current orientation of video detector 12 and a region identified by video analytic system 14 as possibly indicative of fire. Controller 16 generates control instructions that are provided to an actuator controlling video detector 12, thereby focusing the field of view of video detector 12 on the region identified as indicative of fire. Video analytic system 14 continues to analyze the video data provided by video detector 12 to determine whether the video data indicates the presence of fire. As a result of the re-orientation of video detector 12, video analytic system 14 is able to determine with greater certainty whether the region originally identified is indicative of fire.

For example, assume video detector 12 is programmed to pan and tilt as part of a predetermined scan pattern. As video detector 12 scans, video analytic system 14 analyzes the video data and detects a small region within a corner of the field of view of video detector 12 that may be indicative of fire. Due to the location and size of the detected region, the certainty associated with whether the region is indicative of fire is low. In response to video analytic feedback provided, controller 16 generates control instructions to re-orient video detector 12 such that the field of view of video detector 12 is focused on the identified region. In this embodiment, the control scheme employed by controller 16 seeks to reduce or minimize the error between the center of the field of view associated with the video detector and the location of the region identified as potentially indicative of fire. In this way, the field of view of video detector 12 is centered on the region identified as potentially indicative of fire. In cases in which part of the fire was previously outside of the field of view of video detector 12, and therefore not analyzed by video analytic system 14, re-orienting the field of view of video detector 12 allows video analytic system 14 to make a determination regarding the presence of fire based on additional information. In this way, uncertainty associated with an initial determination of whether a region is indicative of fire is improved based on the video analytic feedback control of video detector 12.

Controller 16 may also generate control instructions to control the zoom function of the video detector, such that the region identified as indicative of fire is maximized within the field of view of video detector 12. In the above example, uncertainty associated with whether an analyzed region is indicative of fire can be reduced by causing video detector 12 to zoom in on the initially identified region. In this case, the additional resolution provided by zooming in on the identified region allows video analytic system 14 to make a better determination regarding the presence of fire within an identified region.

Based on the improved orientation of video detector 12 (e.g., panning, tilting and/or zooming to focus on an identified area), video data provided to video analytic system 14 is analyzed to determine with greater reliability whether the identified region is indicative of fire. If the area is not indicative of fire, then video camera 12 continues to scan the region as before. If the area is verified as indicative of fire, then an output is generated to trigger an alarm or otherwise provide notice of the detected presence of a fire.

Controller 16 has been described as physically altering video detector 12 to achieve pan, tilt, and zoom functionality. It will be clear to one of ordinary skill in the art that the same control may be applied to electronic pan, tilt, zoom cameras that effectively pan, tilt, and zoom by selecting certain pixels in an imaging chip rather than by physical movement. Similarly, it will be clear to one of ordinary skill in the art that other camera controls may be affected such as white balance, f-stop, shutter speed, etc.

In another embodiment, used alone or in conjunction with the embodiment in which controller 16 controls the operation and orientation of video detector 12, controller 16 employs video analytic feedback to control the operation of video analytic system 14. This may include modifying both the algorithms used to calculate the video metrics as well as the detection schemes employed to determine whether, based on the calculated metrics, a region is indicative of fire.

Controller 16 may generate the control instructions based on both the video analytic feedback provided by video analytic system as well as knowledge regarding the present state of video detector 12. For instance, in the example described with respect to controlling the pan, tilt and zoom of video detector 12 in response to a small region indicative of fire detected by video analytic system 14, controller 16 may cause video detector 12 to zoom in on the detected region. As a result, controller 16 is aware that the resolution of video data provided by video detector 12 has improved to some extent (e.g., a pixel that previously represented a one meter by one meter area, may represent after zooming a one centimeter by one centimeter region). Providing this information as part of a feedback loop allows video analytics system 14, and in particular, the detector schemes (i.e., algorithms used to analyze whether the calculated video metrics are indicative of fire) to be optimized based on the known resolution. In one embodiment, this may include modifying the detection times and thresholds associated with the detection scheme. For instance, knowledge that a single pixel represents a small one centimeter by one centimeter region may result in controller 16 generating instructions to modify the thresholds associated with the detector. As a result, video metrics generated with respect to a single pixel that previous thresholds would have associated with indicative of a fire, will not trigger an identification of a fire event under the new thresholds (based on knowledge that fires typically are not found on such small scales).

In another embodiment, the algorithm(s) employed by video analytic system (i.e., the algorithms used to calculate video metrics) may be modified based on feedback provided by controller 16. For example, during normal operation (e.g., no detected presence of fires), video analytic system 14 may not apply all available resources to determining whether a particular region is indicative of fire. In particular, algorithms that have heavy processing requirements may be disabled during normal operations. In response to video analytic feedback identifying a region possibly indicative of fire, controller 16 may generate control instructions that cause video analytic system 14 to initiate these additional algorithms to determine with a greater degree of certainty whether the region is indicative of fire. For example, video metrics associated with color, frequency, and intensity may be used initially to identify regions indicative of fire. In response to an identified region, controller 16 would instruct video analytic system 14 to apply additional algorithms, such as an algorithm used to identify and analyze the geometric properties of the identified region, to determine whether the region is indicative of fire. This may be done in combination with other control operations, such as orienting of video detector 12 to improve the field of view, or modifying both the algorithms used to calculate the video metrics as well as the detection thresholds.

The present invention therefore employs the video analytic output in a feedback loop that controls the operation of video-based fire detection system 10. This may include controlling orientation of the video detector such that the field of view of the video detector improves the ability of video analytic system 14 to determine whether an identified region is indicative of fire, as well as controlling the operation of video analytic system 14 to improve the uncertainty associated with determining whether a region is indicative of fire. In this way, the present invention decreases the number of false alarms.

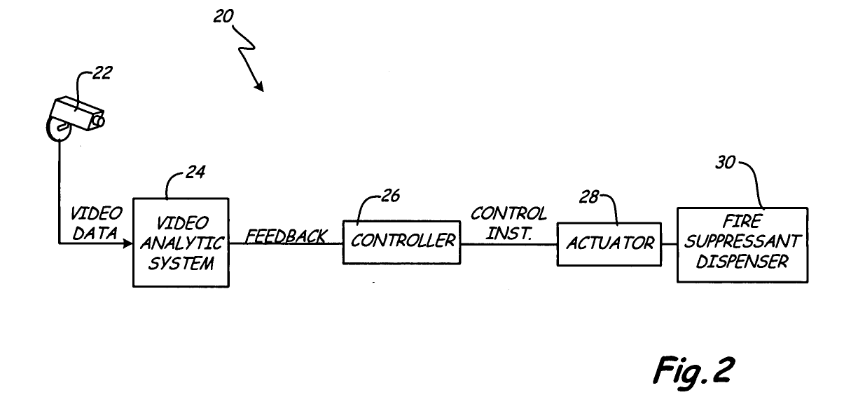

FIG. 2 is a block diagram that illustrates a closed-loop, video-based fire detection system 20 that employs video analytics in a feedback loop to control the operation of a fire-suppressant dispenser. Video-based fire detection system 20 includes video detector 22, video analytic system 24, controller 26, actuator 28, and fire suppressant dispenser 30. Video data captured by video detector 22 is once again provided to video analytic system 24 for analysis. Part of this analysis may include the closed-loop verification of fires as described with respect to FIG. 1. In response to a detected fire, outputs generated by video analytics system 24 indicating the size and location of the fire is provided to controller 26, which initiates fire suppressant dispenser 30 to initiate delivery of the suppressant.

Fire suppressant dispensers such as water cannons have been employed in the past in combination with fire detection systems. These conventional systems, however, were employed as open-loop systems initiated in response to a detected fire, but without any sort of mechanism by which the response could be modified. For example, in a conventional system, a water cannon may be initiated based on output from a video analytics system indicating the size and location of the fire. However, environmental factors such as the wind may adversely affect the delivery of the water to the location of the fire. In an open-loop system, there is no way of modifying the delivery of the suppressant.

The present invention employs video detector 22 and video analytic system 24 to detect the delivery location of the fire suppressant. In response to video data provided by video detector 22, video analytic system 24 generates outputs with respect to both the fire (e.g., size, location, etc.) and the delivery of the suppressant (e.g., location), which are used in a feedback loop to improve the delivery of the suppressant. Detection of the delivered suppressant may be based on well-known video analytic methods, such as motion detection schemes. In particular, suppressants that have smoke-like features, such as gaseous plumes, must be distinguished from the smoke generated by a fire. This may be accomplished by well known analytic techniques that exploit the different motion of smoke and suppressant.

Controller 26 receives the calculated video analytic feedback and seeks to minimize the error between the size and location of the fire and the delivery location and dispersal pattern of the suppressant. As a result, controller 26 generates control instructions that are provided to actuator 28, which modifies the orientation and dispersal pattern of fire suppressant dispenser 30 to optimally deliver the suppressant to extinguish the fire. In this way, the presence of unknown factors such as wind or changes in the suppressant system from when it was initially calibrated, which might otherwise distort the delivery of the suppressant, can be accounted for through the use of video analytic feedback control.

In another embodiment, controller 16 employs video analytic feedback identifying the location of fire (in particular smoke), to control various types of fire suppressant devices, such as fans used to evacuate smoke from a region. In this embodiment, in response to video data provided by video detector 22, video analytic system 24 generates outputs that identify the presence and location of smoke within a region. In response to the detected presence and location of smoke, controller 26 generates control instructions to selectively cause one or more smoke evacuation fans (may be included as part of fire suppressant dispenser 30 or a provided separately) to be activated. In this way, controller is able to monitor the dispersion of smoke based on the video analytic feedback and provide a response that will evacuate the smoke in a desirable way (i.e., not into the path of emergency exits, etc.). In addition, output provided by video analytics system 24 may identify the presence of occupants. In response to occupant feedback as well as feedback regarding the presence of fire (smoke and/or flame) is employed by controller 26 to control the operation of the smoke evacuation fans. For instance, controller 26 may selectively activate smoke evacuation fans directly ahead of occupants exiting a building.

In this way, the present invention employs video analytic feedback to control the operation of fire suppression systems. This use of video analytic feedback may be used alone or in combination with the system described with respect to independent claim 1, wherein video analytic feedback was used to control the operation of video-based fire detection system. In this way, the present invention employs video analytic feedback to improve both the detection stage and response stage of fire-based systems.

Although the present invention has been described with reference to preferred embodiments, workers skilled in the art will recognize that changes may be made in form and detail without departing from the spirit and scope of the invention. In particular, two embodiments have been described which take advantage of closed-loop control, including closed-loop control of the orientation of a video detector to improve the detection (e.g., decreasing missed detections and nuisance alarms) of fire, and closed-loop control of a fire suppressant system that minimizes the error between the location of the fire and the delivery of the suppressant. In other embodiments, the capabilities of video analytics may be employed to control other aspects of fire-detection and suppression.

1. A closed-loop control system comprising:
a video analytic system operably connectable to receive video data from a video detector and to generate, in response to the video data, video analytic feedback; and
a controller connectable to receive the video analytic feedback generated by the video analytic system and to generate, in response to the feedback, control instructions, monitored by the video analytic system, that result in a modification of the closed-loop control system.

2. The closed-loop control system of claim 1, wherein the video analytic feedback generated by the video analytic system includes feedback identifying regions within a field of view of the video detector indicative of fire.

3. The closed-loop control system of claim 2, wherein the controller generates in response to the feedback identifying regions indicative of fire control instructions provided to control the operation of the video detector.

4. The closed-loop control system of claim 3, wherein the control instructions provided to control the operation of the video detector operate to control pan, tilt and zoom functions of the video detector such that the field of view analyzed by the video analytic system is modified.

5. The closed-loop control system of claim 3, wherein the controller generates control instructions that cause the video detector to pan and tilt such that an error between the regions identified as indicative of fire and a center of the field of view associated with the video detector is minimized.

6. The closed-loop control system of claim 3, wherein the controller generates control instructions that cause the video detector to control a zoom function of the video detector such that the region identified as indicative of fire is maximized within the field of view of the video detector.

7. The closed-loop control system of claim 2, wherein the controller generates in response to the feedback identifying regions indicative of fire control instructions provided to control the operation of the video analytic system.

8. The closed-loop control system of claim 7, wherein control instructions provided to the video analytic system modify video metric algorithms employed by the video analytic system in identifying regions within the field of view of the video detector indicative of fire.

9. The closed loop control system of claim 7, wherein control instructions provided to the video analytic system modify detection algorithms employed by the video analytic system in identifying regions within the field of view of the video detector indicative of fire.

10. The closed-loop control system of claim 1, wherein the video analytic system generates a video analytic feedback identifying a delivery location of a fire suppressant.

11. The closed-loop control system of claim 10, wherein the controller generates control instructions to re-orient delivery of the fire suppressant such that an error between the detected location of the region identified as indicative of fire and the delivery location of the fire suppressant is minimized.

12. A closed-loop control system for use with a video-based fire detection system having a video detector responsive to control instructions, the closed-loop control system comprising:
a video analytic system operably connectable to receive video data from a video detector and to generate in response video analytic feedback identifying regions within a field of view of the video detector indicative of fire; and
a controller connected to receive the video analytic feedback generated by the video analytic system and to generate in response control instructions provided to control the operation of the video-based fire detection system.

13. The closed-loop control system of claim 12, wherein the controller generates control instructions provided to control the orientation of the video detector to modify the field of view of the video detector such that the video analytics system can determine with a higher degree of certainty whether a region is indicative of fire.

14. The closed-loop control system of claim 12, wherein the controller generates control instructions provided to the video analytics system to modify video metric algorithms performed by the video analytics system in determining whether a region is indicative of fire.

15. The closed-loop control system of claim 12, wherein the controller generates control instructions provided to the video analytics system to modify detection algorithms performed by the video analytics system in determining whether video metrics calculated by a video metric algorithm is indicative of fire.

16. A closed-loop system for deploying a fire suppressant, the closed-loop system comprising:
a video analytic system operably connectable to receive video data from a video detector and to generate in response video analytic feedback identifying regions within a field of view of the video detector indicative of fire and a delivery location of a fire suppressant delivered in response to a detected fire; and
a controller connected to receive the video analytic feedback generated by the video analytic system and to generate in response control instructions provided to control the operation of a fire suppressant delivery system to minimize an error between the region identified as indicative of fire and the location of the delivered fire suppressant.

17. A method of employing video analytics in a closed-loop fire detection and suppression system, the method comprising:
acquiring video data from a video detector;
applying video analytics to the acquired video data to calculate video analytic feedback identifying regions within a field of view of the video detector indicative of fire;
applying the calculated video analytic feedback to a controller;
calculating control instructions to modify the operation of the fire detection and suppression system based on the video analytic feedback to maximize the ability of video analytic feedback to identify the presence of fire within the field of view of the video detector; and
verifying whether the region identified as indicative of fire contains fire based on video analytic outputs generated in response to the modified operation of the fire detection and suppression system.

18. The method of claim 17, wherein calculating control instructions further includes:
generating control instructions to control the orientation of the video camera such that the field of view of the video detector is modified to decrease an error between a center of the field of view of the video detector and the region identified as indicative of fire.

19. The method of claim 17, wherein calculating control instructions further includes:
generating control instructions to control the operation of a video analytics system such that the modified video analytic feedback provided by the video analytics system improves uncertainty regarding whether a region is indicative of fire.

20. The method of claim 17, wherein applying video analytics to the acquired video data includes:
calculating a delivery location of a fire suppressant delivered in response to region identified as indicative of fire.

21. The method of claim 20, wherein calculating control instructions includes:
generating control instructions to modify the delivery of the fire suppressant based on the video analytic feedback such that the difference between the region identified as indicative of fire and the delivery location of the fire suppressant is minimized; and
applying the control instructions to a fire suppressant delivery system to modify the delivery location of the fire suppressant.
